(19) United States
(12) Patent Application Publication
(10) Pub. No.: US 2016/0283878 A1
(43) Pub. Date: Sep. 29, 2016

(54) SYSTEM AND METHOD TO USE MULTI-FACTOR CAPACITY CONSTRAINTS FOR PRODUCT-BASED RELEASE AND TEAM PLANNING

(71) Applicant: CA, Inc., New York, NY (US)

(72) Inventors: Brian E. Nathanson, Fairfax, VA (US); James N. K. Chan, Staten Island, NY (US)

(73) Assignee: CA, Inc.

(21) Appl. No.: 14/667,054

(22) Filed: Mar. 24, 2015

(51) Int. Cl. G06Q 10/06

(52) U.S. Cl. CPC G06Q 10/06313; G06Q 10/06314; G06Q 10/06315

(57) ABSTRACT

In a computer-implemented method of performing operations on a processor, a fixed timeframe associated with release of a product is defined, and resource profiles including capacity metrics indicating capacities of respective resources that are available for the fixed timeframe and respective costs associated therewith are generated. Scope elements including demand metrics associated with implementation of respective features of the product within the fixed timeframe are also generated. For different combinations comprising ones of the scope elements, respective expenses associated with implementation of the respective features thereof are dynamically computed, based on the demand metrics therefor relative to the capacity metrics of the respective resources that are available for the fixed timeframe. Related computer systems and computer program products are also discussed.

### BACKGROUND

The present disclosure relates generally to the technical field of data processing, and more specifically to project management systems.

Project management generally refers to the managing of individual personnel (resources), time, cost, and performance to complete a project involving a plurality of tasks. The tasks are typically defined so that completion of work associated with each of the tasks results in successful completion of the project. Project management systems have been developed to assist operators (e.g., project managers) with performing project management. One software based project management system is CA Clarity™, which provides project and portfolio management (PPM) capabilities.

Some conventional project management tools, typically provide environments for managing events within a project, with the ability to roll up events, indicate predecessors of events, calculate critical paths, reschedule events in order to optimize the project schedule, generate reports, etc. In this regard, project managers typically manually input the tasks necessary for the completion of a project into a project management tool along with information about each task, such as task dependencies, resources required, and the estimated times for completing each of the tasks. The project management tool uses this information to create a project schedule. Once the project schedule is created, task status information is input into the project management tool in order to monitor and report project progress. Project managers are able to manually update the performance statuses of the tasks in the project management tool. The project management tools are also able to generate reports on the progress of the project, reanalyze the schedule, compute new estimated times to complete the project, and possibly reallocate resources.

During the planning stage, organizations may often need to match available resource (personnel) capacity with work demand, as measured by various units (e.g., hours, points, etc.). Project managers may accomplish this via spreadsheets and other manipulation, by manually analyzing task requirements and capability profiles for individual personnel resources to attempt to decide upon an optimal assignment of resources to tasks. However, because of the potentially large number of tasks and factors to be considered, the assignment process may need to be repeated many times to reach an acceptable solution and may still not be considered optimal for performance of the tasks and satisfaction of the personnel resources. Moreover, project managers can become bottlenecks in the planning stage of projects because of the complexity of this stage.

### SUMMARY

Some embodiments of the present disclosure are directed to a computer-implemented method of performing operations on a processor. In performing the operations, a fixed timeframe associated with release of a product is defined, and resource profiles including capacity metrics indicating capacities of respective resources that are available for the fixed timeframe and respective costs associated therewith are generated. Scope elements including demand metrics associated with implementation of respective features of the product within the fixed timeframe are also generated. For different combinations comprising ones of the scope elements, respective expenses associated with implementation of the respective features thereof are dynamically computed, based on the demand metrics therefor relative to the capacity metrics of the respective resources that are available for the fixed timeframe.

In some embodiments, the respective expenses may be projected expenses. For one of the different combinations, an actual expense of implementation of one of the respective features thereof may be computed, based on spent portions of the capacity metrics of the respective resources at a time during the fixed timeframe and the respective costs associated therewith. A visual representation of the actual expense may be presented via a user interface of a product management system.

In some embodiments, for the one of the different combinations, a progress measurement with respect to the one of the respective features thereof may be computed, based on a difference between the demand metrics therefor and spent portions the capacity metrics of the respective resources at a time during the fixed timeframe. A visual representation of the progress measurement may be presented via a user interface of a product management system.

In some embodiments, for the one of the different combinations, a projected outcome with respect to completion of the one of the respective features thereof may be computed based on a difference between the demand metrics therefor and spent portions the capacity metrics of the respective resources at a time during the fixed timeframe relative to a remaining portion of the fixed timeframe. A visual representation of the projected outcome may be presented via a user interface of a product management system.

In some embodiments, for the one of the respective features, a release velocity may be computed based on the spent portions of the capacity metrics relative to a difference between the fixed timeframe and the remaining portion of the fixed timeframe. The projected outcome may be computed based on the release velocity.

In some embodiments, the scope elements may further indicate categories of tasks associated with implementation of the respective features. Respective allocations of the spent portions of the capacity metrics among the categories of tasks associated with implementation of the one of the respective features may be determined, and portions of the actual expense may be identified as capital expenditures based on the respective allocations of the spent portions of the capacity metrics among the categories of tasks and the respective costs associated with corresponding ones of the resources.

In some embodiments, based on the projected outcome for the one of the respective features, a recommendation to modify the ones of the scope elements included in the one of the different combinations may be generated. The recommendation may be presented via the user interface of the product management system. A modification with respect to the ones of the scope elements included in the one of the different combinations may be received, and the projected outcome may be dynamically updated based on remaining portions of the capacity metrics of the respective resources responsive to the modification.

In some embodiments, the fixed timeframe may be a first timeframe, and a second timeframe associated with release of a subsequent version of the product may be defined. The recommendation to modify may be a recommendation to move the one of the respective features from the first timeframe to the second timeframe based on the demand metrics therefor relative to capacity metrics of respective resources that are available for the second timeframe.

In some embodiments, the user interface may be a drag-and-drop user interface, and the modification may be received via the drag-and-drop user interface as an instruction to move a visual representation of one of the scope elements corresponding to the one of the respective features from a visual representation of the first timeframe to a visual representation of the second timeframe.

In some embodiments, the respective resources may include a plurality of geographically diverse resources.

In some embodiments, the capacity metrics for respective ones of the resources may be weighted based on relative costs associated therewith.

Further embodiments of the present disclosure are directed to a computer system, including a processor and a memory coupled to the processor. The memory includes computer readable program code embodied therein that, when executed by the processor, causes the processor to perform operations including defining a fixed timeframe associated with release of a product, and generating resource profiles including capacity metrics indicating capacities of respective resources that are available for the fixed timeframe and respective costs associated therewith. The operations further include generating scope elements including demand metrics associated with implementation of respective features of the product within the fixed timeframe, and dynamically computing, for different combinations including ones of the scope elements, respective expenses associated with implementation of the respective features thereof based on the demand metrics therefor relative to the capacity metrics of the respective resources that are available for the fixed timeframe.

Still further embodiments of the present disclosure are directed to a computer program product including a computer readable storage medium having computer readable program code embodied in the medium. The computer readable program code includes computer readable code to define a fixed timeframe associated with release of a product, and computer readable code to generate resource profiles comprising capacity metrics indicating capacities of respective resources that are available for the fixed timeframe and respective costs associated therewith. The computer program code further includes computer readable code to generate scope elements comprising demand metrics associated with implementation of respective features of the product within the fixed timeframe, and computer readable code to dynamically compute, for different combinations comprising ones of the scope elements, respective expenses associated with implementation of the respective features thereof based on the demand metrics therefor relative to the capacity metrics of the respective resources that are available for the fixed timeframe.

Other methods, systems, articles of manufacture, and/or computer program products will be or become apparent to one with skill in the art upon review of the following drawings and detailed description. It is intended that all such additional systems, methods, articles of manufacture, and/or computer program products be included within the scope of the present disclosure. Moreover, it is intended that all embodiments disclosed herein can be implemented separately or combined in any way and/or combination.

### BRIEF DESCRIPTION OF THE DRAWINGS

Other features of embodiments of the present disclosure will be more readily understood from the following detailed description of specific embodiments thereof when read in conjunction with the accompanying drawings, in which:

FIG. 1 is a block diagram of a system for product-based release and team planning using multi-factor capacity constraints according to some embodiments of the present disclosure;

FIGS. 2A and 2B are flowcharts illustrating operations for product-based release and team planning using multi-factor capacity constraints according to some embodiments of the present disclosure;

FIG. 3 illustrates a data processing system that may be used to implement any one or more of the components of FIGS. 1, 2A, and/or 2B according to some embodiments of the present disclosure; and

FIG. 4 is a block diagram of a software and hardware architecture for product-based release and team planning using multi-factor capacity constraints according to some embodiments of the present disclosure; and

FIGS. 5-7 illustrate example user interfaces for product-based release and team planning using multi-factor capacity constraints according to some embodiments of the present disclosure.

### DETAILED DESCRIPTION

Various embodiments will be described more fully hereinafter with reference to the accompanying drawings. Other embodiments may take many different forms and should not be construed as limited to the embodiments set forth herein. Like numbers refer to like elements throughout.

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Various embodiments of the present disclosure may arise from realization that, while groups developing products may need to match product features with product releases given a certain set of constraints, traditional project management solutions typically focus on establishing project scope (i.e., the tasks to be accomplished to deliver a product with specified features/functions) and cost (via task lists and resource assignments), while manipulating the schedule. Embodiments of the present disclosure are instead directed to product-based planning, rather than project-based planning. Such product-based planning efforts may focus on establishing a fixed schedule, while manipulating the product scope (i.e., the features and functions that characterize a product). Project scope may thus be more work-oriented, (the hows), while product scope may be more oriented toward functional requirements (the whats).

Product-based planning efforts according to some embodiments of the present disclosure can provide a more conducive method to establish a fixed schedule, while manipulating scope and introducing the ability to dynamically calculate costs. In particular, product- or scope-based planning in accordance with embodiments of the present disclosure can allow ease of inclusion/exclusion of scope elements (and associated features), can provide a way to define specified or fixed timeframes (buckets) that do not change, can offer a flexible way to set capacity, and/or can provide the ability to calculate costs and provide for capitalization.

Some embodiments of the present disclosure may involve a product-based planning interface that offers ease in matching features with available capacity within a particular timeframe. In some embodiments, such an interface may include information about planned and actual costs, may offer methods of capturing capitalization, and may provide ways to track progress, including costs. Embodiments of the present disclosure may combine characteristics of a drag-and-drop interface for planning releases that reflects scope and capacity metrics (not available in financial systems), and financial budgeting/cost calculation/rollup for features/releases and corresponding ability to capitalize (not available in agile/product planning systems). As such, embodiments of the present disclosure may provide an interface that allows ease of movement of personnel teams and/or other resources and features/deliverables in and out of scope, and immediate viewing of the resulting impact.

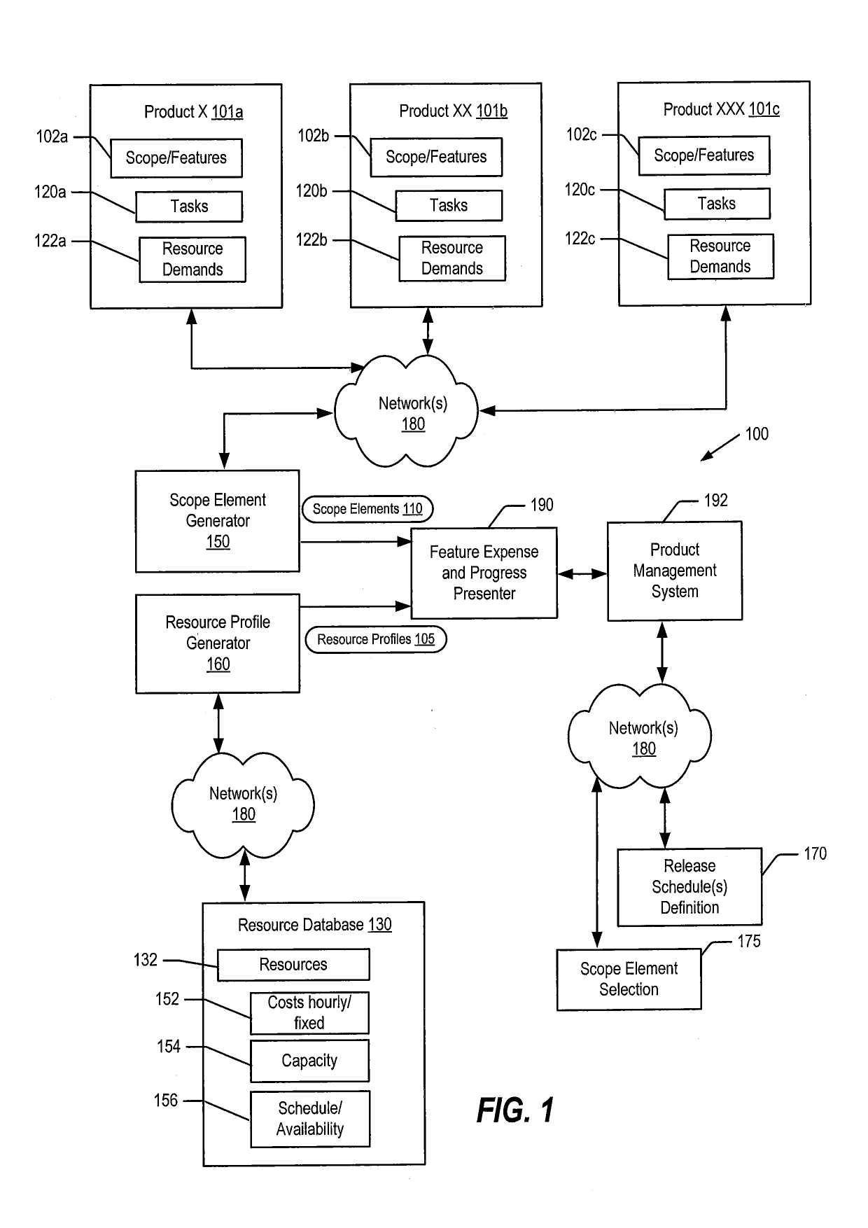

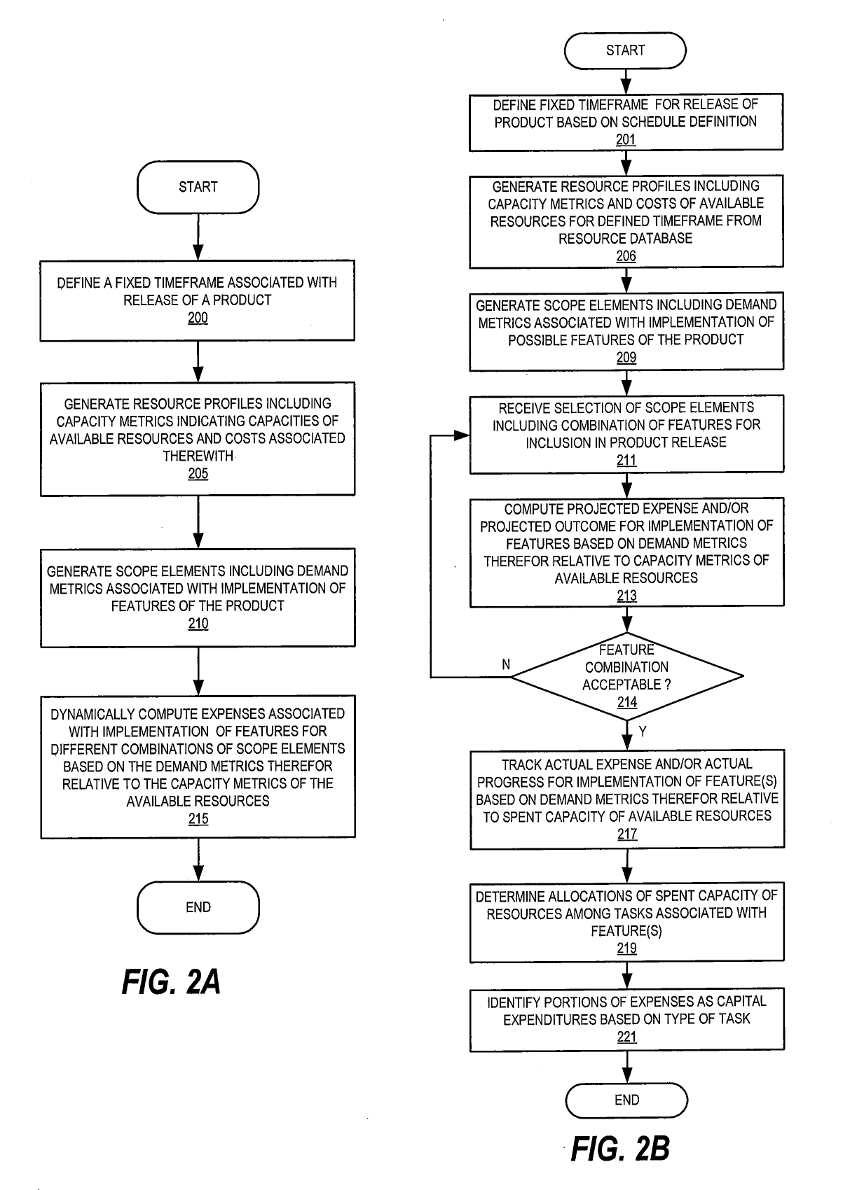

FIG. 1 illustrates a block diagram of an example computing environment or system 100 for product-based release and team planning using multi-factor capacity constraints according to some embodiments of the present disclosure. The system 100 may be a product management system or a project and portfolio management system, or may output information for use by a product management system or a project and portfolio management system. The operations performed by various components of the system of FIG. 1 are also described below by way of example with reference to the flowcharts of FIGS. 2A and 2B; however, it will be understood that the operations of FIGS. 2A and 2B are not limited to the example system architecture of FIG. 1.

Referring now to FIGS. 1 and 2A, the system 100 includes a scope element generator 150 and a resource profile generator 160, whose outputs are provided to a feature expense and progress presenter 190 that outputs information to the product management system 192. The scope element generator 150, the resource profile generator 160, the feature expense and progress presenter 190, and the product management system 192 may be coupled to one another and/or to various other components of the system of FIG. 1 via one or more communications networks 180.

The network(s) 180 can include any wireless and/or wired communication network between computing devices, and may include one or more local area networks (LANs), radio access networks (RANs), metropolitan area networks (MANS), wide area networks (WANs), virtual private networks (VPNs), and/or a portion of the global computer network known as the Internet. Thus, the network(s) 180 may represent a combination of public and private networks or a virtual private network (VPN). Although illustrated as separate networks, it will be understood that the network(s) 180 may represent a same or common network in some embodiments. As such, one or more of the scope element generator 150, the resource profile generator 160, the feature expense and progress presenter 190, and the product management system 192 may be co-located or remotely located, and communicatively coupled by one or more of the network(s) 180.

Operation of the scope element generator 150, the resource profile generator 160, the feature expense and progress presenter 190, and the product management system 192 will now be discussed with reference to the flowchart of FIG. 2A. In particular, based on a schedule definition 170 received at the product management system 192, the product management system 192 defines a fixed timeframe associated with release of a product (Product X) (block 200). The resource profile generator 160 generates resource profiles 105 including capacity metrics, which indicate capacities of respective resources 132 that are available for this fixed timeframe 170, as well as respective costs 152 associated with the resources 132 (block 205). The resource profile generator 160 may calculate the capacity metrics for the resource profiles 105 by assigning point values based on respective capacities 154 and schedules/availabilities 156 of the resources 132, for example, as determined from accessing a resource database 130. The resource database 130 may be a repository (e.g. one or more local or remote memory devices) storing data indicating respective capacities 154, costs 152, and/or availability 156 for thousands of geographically diverse personnel or other resources 132, and may be provided, for example, by an available resources server that is communicatively coupled to the resource profile generator 160 by one or more of the networks 180. The data 152, 154, 156 stored in the resources database 130 may be obtained, for example, from a product management system or a project and portfolio management system.

The scope element generator 150 generates scope elements 110 including demand metrics, which are associated with implementation of respective features 102a of the product (Product X) within the fixed timeframe defined by the schedule definition 170 (block 210). The scope element generator may calculate the demand metrics for the features 102a by assigning point values based on respective tasks or activities 120a and resource demands 122a associated with the features 102a, for example, as determined from accessing a product server 101a that is communicatively coupled to the scope element generator 150 via one or more of the networks 180. One or more additional product servers 101b, 101c may likewise include information about releases of products (Product XX, Product XXX) including respective features 102b, 102c, respective tasks 120b, 120c, and/or respective resource demands 122b, 122c associated therewith. The product servers 101a, 101b, 101c may include one or more local or remote memory devices storing data indicating the scope/features 102a, 102b, 102c, tasks/activities 120a, 120b, 120c, and/or resource demands 122a, 122b, 122c for the respective products X, XX, XXX, which may be defined or otherwise obtained, for example, from a product management system or a project and portfolio management system. In some embodiments (for instance, where the products X, XX, and XXX are different release versions of a same product), the product servers 101a, 101b, 101c may be included in a same server or communicatively coupled servers.

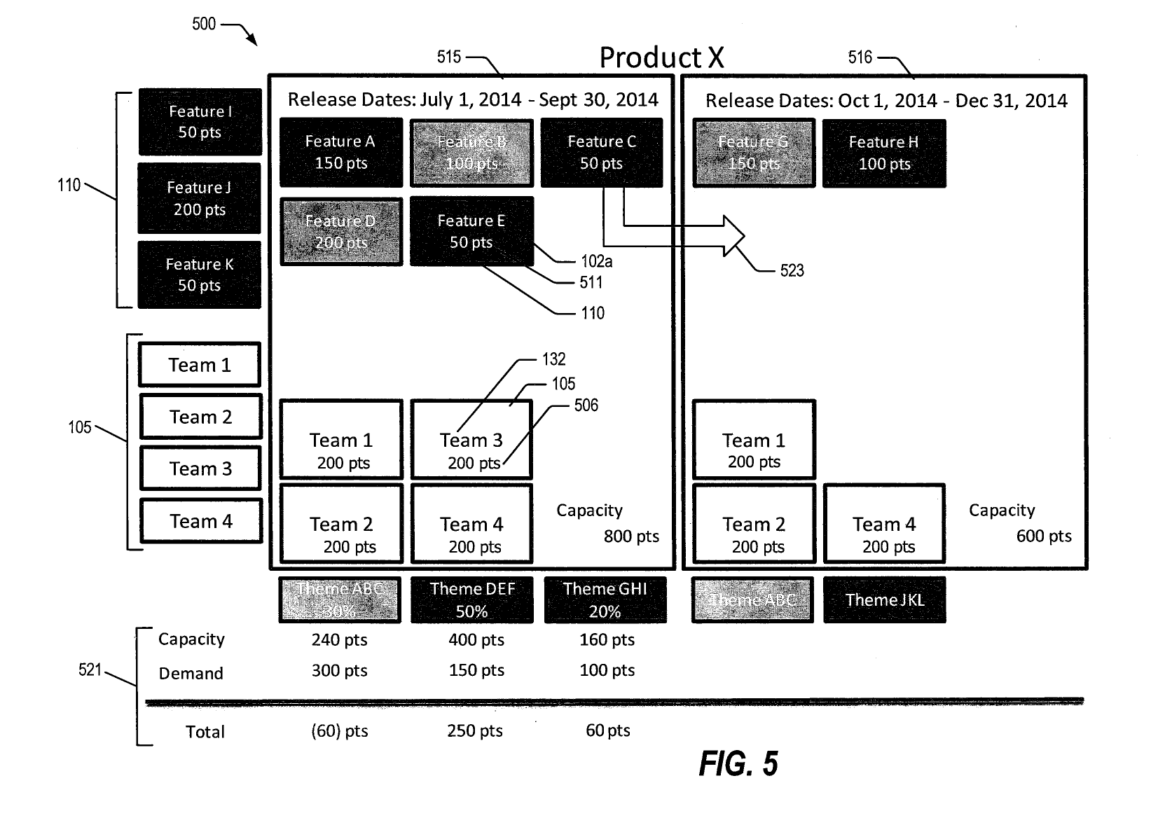

Based on the resource profiles 105 and scope elements 110 output from the resource profile generator 160 and the scope element generator 150, respectively, the feature expense and progress presenter 190 dynamically computes expenses associated with implementation of features 102a for different combinations of the scope elements 110 based on the demand metrics calculated by the scope element generator 150 relative to the capacity metrics of the available resources 132 calculated by the resource profile generator 160 the fixed timeframe specified by the schedule definition 170. The different combinations of the scope elements 110 may be specified by a scope element selection 175 received at the product management system 192, for example, via a user interface thereof. An example drag-and-drop user interface for receiving different combinations of the scope elements 110 is illustrated in FIG. 5.

FIG. 2B illustrates the operations of the system 100 of FIG. 1 in greater detail. Referring now to FIGS. 1 and 2B, responsive to receiving a release schedule definition 170 from a user via a network 180, a fixed timeframe associated with release of a product (product X) 101a is defined by the product management system 192 based on the schedule definition 170 at block 201. At block 206, responsive to accessing a resource database 130, a plurality of resource profiles 105 are generated by the resource profile generator 160. The resource profiles 105 define capacity metrics, which indicate respective capacities 154 of resources 132 that are available during the defined schedule, as well as costs 152 associated with the available resources 132, based on data stored in the resource database 130. For example, the resource database 130 may include stored data indicating schedules/availability 156 for each of the resources 132, hourly and/or fixed costs 152 associated with the resources 132, and/or respective capacities 154 of the resources 132 over the time periods covered by the schedules/availability 156. The resource profile generator 160 may quantify such data stored in the resource database 130 (for instance, as point values) to define the capacity metrics for each of the resources 132 that are available for the fixed timeframe indicated by the release schedule definition 170. In some embodiments, the resource profile generator 160 may weight the capacity metrics for the resources to reflect the relative costs 152 associated therewith. The resource profiles 105, including the associated capacity metrics, may be provided to the product management system 192 for presentation to a user thereof, for example, via a drag-and drop user interface.

Still referring to FIGS. 1 and 2B, a plurality of scope elements 110 are generated by the scope element generator 150 at block 209, for example, responsive to accessing a product server that specifies potential features 102a to be included in the product (product X) 101a. The scope elements 110 include demand metrics associated with implementation of the possible features 102a that may be included in the product (product X) 101a. For example, the product server may include stored data indicating tasks 120a and/or resource demands 122a associated with each of the features 102a, and the scope element generator 150 may quantify such data (for instance, as point values based on a similar scale used for the capacity metrics) to define the demand metrics for each of the features 102a. The scope elements 110, including the associated demand metrics, may be provided to the product management system 192 for presentation to a user thereof, for example, via a drag-and drop user interface.

At block 211, a selection 175 including a combination of the scope elements 110 (and/or the features associated therewith) desired for the product release is received at the product management system 192, for example, via a drag-and-drop user interface of the product management system 192, as illustrated in FIG. 5. Based on the demand metrics for the features specified in the selection 175 (as provided by the associated scope elements 110) relative to the capacity metrics of the available resources 132 (as provided by the associated resource profiles 105), projected expenses and/or projected outcomes for implementing the features specified in the selection 175 are computed by the feature expense and progress presenter 190 at block 213. For example, at a planning stage, the feature expense and progress presenter 190 may compare a sum of the demand metrics/point values for the features specified in the selection 175 to a sum of the capacity metrics/point values for the resources 132 that are available during the fixed timeframe to determine a projected outcome or likelihood of successfully implementing the features specified in the selection 175 during the fixed timeframe. The feature expense and progress presenter 190 may likewise compute the projected expenses of implementing the features specified in the selection 175 based on the costs associated with the capacity metrics/point values required of the resources 132 to meet the demand metrics/point values for the features specified in the selection 175. The projected expenses and/or projected outcomes for the features specified in the selection 175 may be provided as outputs from the feature expense and progress presenter 190 to the product management system 192 for presentation to a user thereof, for example, via a user interface.

If, based on the projected expenses and/or projected outcomes computed at block 213, it is determined at block 214 that the combination of features included in the selection 175 are not acceptable (for example, with respect to the schedule definition 170 or defined timeframe), a new selection 175 including a combination of different scope elements 110 (and/or the features associated therewith) is received at the product management system 192 at block 211. For example, the new selection of scope elements 110 and/or associated features 175 may be received via the drag-and-drop user interface of the product management system 192, as illustrated in FIG. 5. As such, projected expenses and/or projected outcomes for implementing the different combination of features specified in the new selection 175 are dynamically computed or updated by the feature expense and progress presenter 190 responsive to changes in the selection 175 at block 213, based on the demand metrics therefor relative to the capacity metrics of the available resources 132 during the fixed timeframe defined from the schedule definition 170.

If, based on the projected expenses and/or projected outcomes computed at block 213, it is determined at block 214 that the combination of features included in the selection 175 are acceptable, a more detailed analysis may be computed by the feature expense and progress presenter 190 based on actual implementation of one or more of the features included in the selection 175. In particular, at any given time during the fixed timeframe, actual expenses and/or actual progress with respect to implementation of one or more of the features included in the selection 175 is computed by the feature expense and progress presenter 190, based on the demand metrics therefor relative to spent portions of the capacity metrics of the respective resources 132. For example, the feature expense and progress presenter 190 may calculate the actual expense of implementing one of the features included in the selection 175 based on the cost associated with the spent portions of the capacity metrics/point values of one or more of the resources 132 allocated to that particular one of the features as of a particular time during the fixed timeframe. Likewise, the feature expense and progress presenter 190 may compute a progress measurement with respect to one of the features included in the selection 175 based on a difference between the demand metrics/point values associated with implementation of that particular feature and the spent portions of the capacity metrics/point values of one or more of the resources 132 allocated to that particular feature as of a particular time during the fixed timeframe.

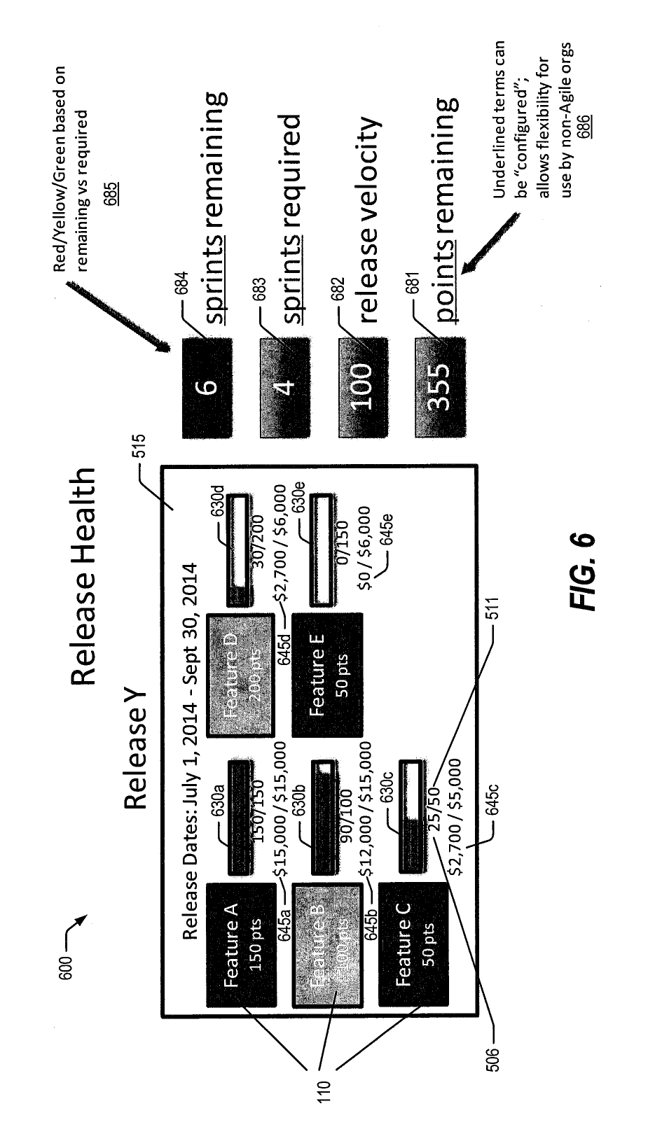

In addition, the projected outcome(s) for one or more of the features included in the selection 175 (for example, as computed at block 213) may be re-calculated or updated by the feature expense and progress presenter 190 based on the actual progress computed at block 217 and the passage of time during the fixed timeframe. As such, the feature expense and progress presenter 190 may recursively compute and/or revise a projected progress or likelihood of completion of one or more of the features included in the selection 175 in real time, based on the actual progress at any given time during the fixed timeframe relative to the remaining portion of the fixed timeframe. Examples of computing such actual expenses, progress measurements, and updated outcome projections in accordance with some embodiments of the present disclosure are illustrated in FIG. 6 (with respect to Release Y of Product X) in greater detail.

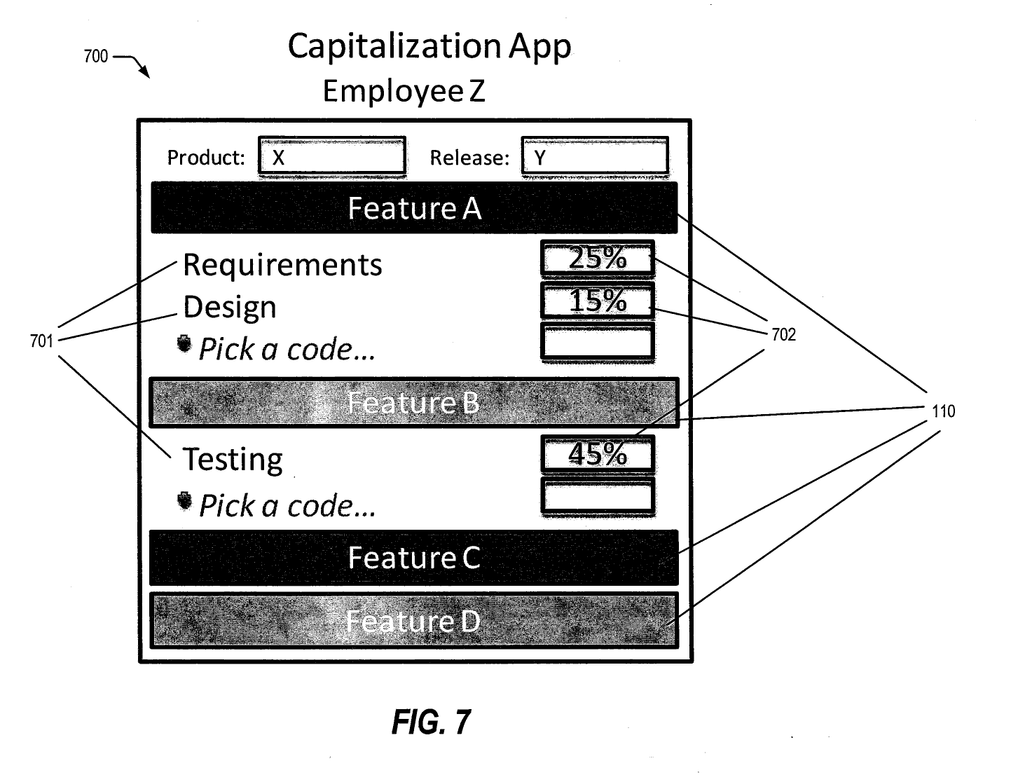

At block 219, allocations of the spent capacity of one or more of the resources 132 among the tasks 120a associated with the features 102a included in the selection 175 are determined by the feature expense and progress presenter 190. For example, indications may be received from one or more individuals associated with one or more of the resources 132 via a user interface of the product management system 192 as to a portion of the capacity metrics/point values and/or a percentage of the fixed timeframe spent on each of the various activities/tasks 120a (e.g., requirement definition, design, testing, etc.) associated with implementation of particular one of the features 102a. In some embodiments, for instance, the tasks 102a may be identified by charge codes, which may be mapped to categories or types of work that may be considered as capital expenditures. Based on the category type of task/activity 120a and the spent capacity allocated thereto at block 219, portions of the actual expenses computed at block 217 may be identified as capital expenditures at block 221. Examples of spent capacity allocation among categories of tasks and expense capitalization in accordance with some embodiments of the present disclosure are illustrated in FIG. 7 (with respect to a Capitalization App for an employee Z) in greater detail.

Although illustrated by way of example with reference to a limited quantity of products X, XX, and XXX and resources 132 in FIG. 1, it will be understood that embodiments of the present disclosure may allow for management of hundreds of products based on coordination of availability and costs of thousands of resources, as well as dynamic computation of projected and actual expenses associated with implementation of various feature combinations for the products, based on multiple fixed and/or changing constraints in real-time. Thus, systems and methods for product-based release and team planning using multi-factor capacity constraints according to some embodiments of the present disclosure involve operations that would not be possible for one or more human product managers to implement absent the teachings described herein.

It will be appreciated that in accordance with various embodiments of the present disclosure, the components 150, 160, and/or 190 of the product management system 192 may be implemented as a single server, separate servers, or a network of servers (physical and/or virtual), which may be co-located in a server farm or located in different geographic regions. More generally, although FIG. 1 illustrates an example of a computing environment 100 for product-based release and team planning using multi-factor capacity constraints, it will be understood that embodiments of the present disclosure are not limited to such a configuration, but are intended to encompass any configuration capable of carrying out the operations described herein. Likewise, the flowcharts of FIGS. 2A and 2B illustrate operations for product-based release and team planning using multi-factor capacity constraints by way of example, and thus, it will be understood that embodiments of the present disclosure are not limited to such operations and/or the sequence of operations illustrated.

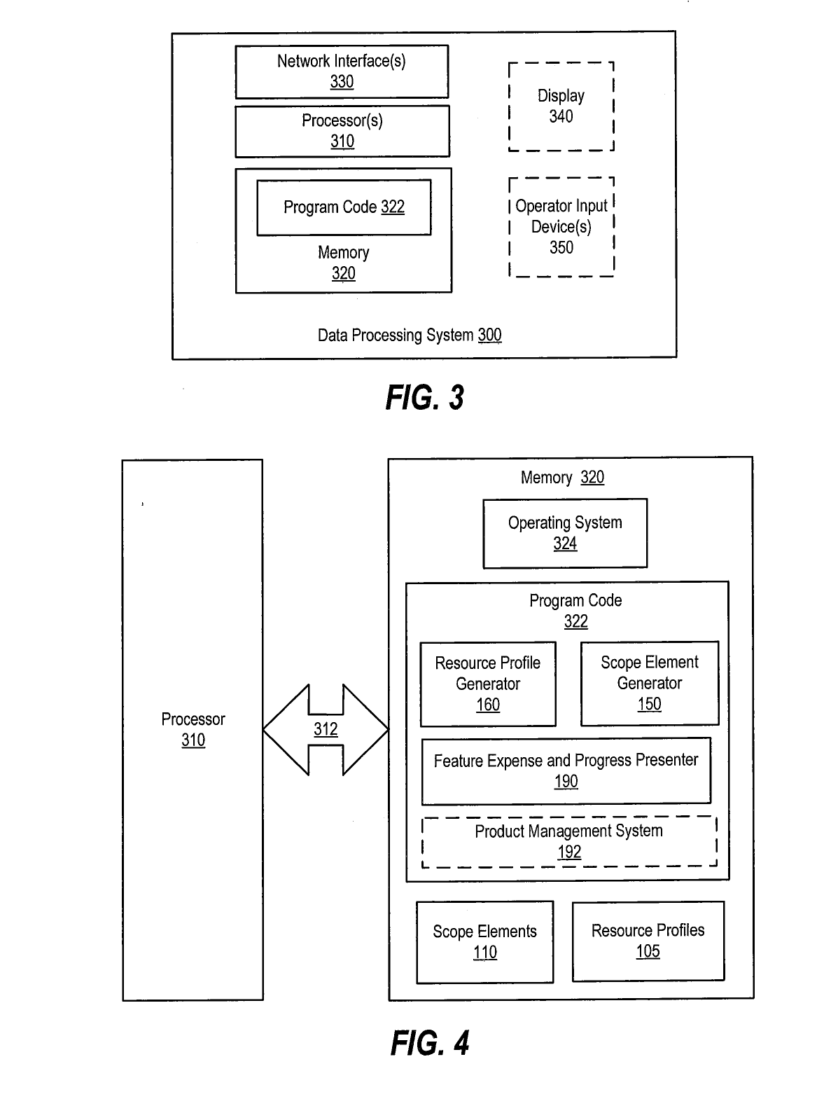

FIG. 3 illustrates an example computing device or data processing system 300 in accordance with some embodiments of the present disclosure. The data processing system 300 may be used, for example, to implement the scope element generator 150, the resource profile generator 160, the feature expense and progress presenter 190, and/or the product management system 192 in the system 100 of FIG. 1 using hardware, software implemented with hardware, firmware, tangible computer-readable storage media having instructions stored thereon, or a combination thereof, and may be implemented in one or more computer systems or other processing systems. The data processing system 300 may also be a virtualized instance of a computer. As such, the devices and methods described herein may be embodied in any combination of hardware and software.

Referring now to FIG. 3, a data processing system 300, which may be used to implement one or more of the components of FIGS. 1, 2A, and 2B according to some embodiments of the present disclosure, includes one or more network interfaces 330, processor circuitry (“processor”) 310, and memory 320 containing program code 322. The processor 310 may include one or more data processing circuits, such as a general purpose and/or special purpose processor (e.g., microprocessor and/or digital signal processor) that may be collocated or distributed across one or more networks. The processor 310 is configured to execute program code 322 in the memory 320, described below as a computer readable storage medium, to perform some or all of the operations and methods that are described above for one or more of the embodiments, such as the embodiments of FIGS. 1, 2A, and 2B. The data processing system 300 may also include a display device 340 (which may display a drag-and-drop user interface generated by the product management system 192) and/or an operating input device 350, such as a keyboard, touch sensitive display device, etc. The network interface 330 can be configured to communicate through one or more networks with any of the resource database 130 or associated available resource server(s), the product server(s) 101a, 101b, 101c, the scope element generator 150, the resource profile generator 160, the feature expense and progress presenter 190, and/or the product management system 192 in the system 100 of FIG. 1.

FIG. 4 illustrates a processor 310 and memory 320 that may be used in embodiments of data processing systems 300 in greater detail. The processor 310 communicates with the memory 320 via an address/data bus 312. The memory 320 may include the repository of project requirements 100 and/or the repository of resource profiles 105 160. The program code 322 may include the resource profile generator 160, the scope element generator 150, the feature expense and progress presenter 190, and/or the product management system 192. The memory 320 may further include an operating system 324 that generally controls the operation of the data processing system. In particular, the operating system 324 may manage the data processing system's software and/or hardware resources and may coordinate execution of programs by the processor 310. The memory 320 may further store the resource profiles 105 and/or the scope elements 110 generated by the resource profile generator 160 and/or the scope element generator 150, respectively.

The processor 310 may thus execute the program code 322 to generate a cost-focused product-based planning user interface that provides visual representations of the scope elements 110 and resource profiles 105, allowing users to match product features with available capacity for a predefined timeframe. In particular, embodiments of the present disclosure provide a drag-and-drop user interface that allows for a planning aspect (prior to execution) where product features to be implemented can be matched with available capacity, as well as a cost aspect (during execution) that can indicate actual and/or projected costs (in terms of resources and/or dollar amounts) for the features that have been implemented based on the actual performance over the given timeframe. Embodiments of the present disclosure further provide the ability to track progress, including costs, at any given time during the timeframe, as well as capture capitalization, based on the types or categories of tasks involved with the costs.

FIGS. 5-7 illustrate example user interfaces for product-based release and team planning using multi-factor capacity constraints according to some embodiments of the present disclosure. In particular, FIG. 5 illustrates a user interface 500 generated for use during the product planning aspect of product-based release, while FIGS. 6 and 7 illustrate example user interfaces 600 and 700 generated for use during execution or implementation aspects of product-based release.

As shown in FIG. 5, the product planning user interface 500 presents a visual representation of scope elements 110 (as generated by the scope element generator 150) including features 102a of a product (Product X) to be implemented, a visual representation of resource profiles 105 (as generated by the resource profile generator 160) including resources 132 that are available to implement the features 102a, and one or more fixed timeframes 515, 516 associated with release of the product. The scope elements 110 and/or the resource profiles 105 can be dragged-and-dropped into (or out of) one of the timeframes 515, 516. The user interface 500 thus allows for management of the scope elements 110 (and associated product features) based on multiple constraints.

In particular, in some embodiments, the timeframe 515 and the resources 132 (including costs 152, capacity 154, and availability 156) may be received as fixed constraints. For example, based on a release schedule definition 170 received from a user, fixed timeframes 515, 516 corresponding to the dates specified in the release schedule definition 170 may be defined and displayed via the user interface 500, and ones of the resources 132 (illustrated as Teams 1 2, 3, and 4) that are available for the timeframes 515, 516 may be identified. Resource profiles 105, including capacity metrics 506 (illustrated as point values), are thus generated based on the availability 156 of the resources 132 (Teams 1-4) for the defined timeframes 515, 516, and the capacities 154 and costs 152 associated with the resources 132. The user interface 500 displays visual representations of the resource profiles 105, one or more of which can be dragged-and-dropped into one or more of the timeframes 515, 516 responsive to user input. The resources 132 represented by the resource profiles 105 generated in accordance with embodiments of the present disclosure may include hundreds or even thousands of geographically diverse resources (e.g., employees/personnel) that are available for the defined timeframe 515. The user interface 500 thus provides visual representations of up to thousands of fixed constraints by which a user (such as a product manager) may utilize in managing the release of the product (Product X).

Still referring to FIG. 5, scope elements 110, including demand metrics 511 (illustrated as point values) indicative of requirements for implementing one or more product features 102a (shown in FIG. 5 as Features A, B, C, D, and E; also referred to herein as deliverables), are generated based on the tasks 120a and resource demands 122a associated with the features 102a. The user interface 500 likewise displays visual representations of the scope elements 110, one or more of which can similarly be dragged-and-dropped into one or more of the timeframes 515, 516 responsive to scope element selection 175 received from a user. Based on the capacity metrics 506 of the available resources 132 relative to the demand metrics 511 for the features 102a (Features A-E) corresponding to the combination of scope elements 110, a likelihood of implementation 521 of combinations of the features 102a (Features A-E) during the defined timeframe 515 may be computed and displayed via the user interface 500.

While the values of the capacity metrics 506 may be fixed based on the availability of the resources 132 during the timeframe 515, the values of the demand metrics 511 can be varied by adding or removing scope elements 110 from the defined timeframe 515. As such, the demand metrics 511 (and thus, the likelihood of implementation 521) are updated as scope elements 110 are dragged-and-dropped into the timeframes 515, 516. The likelihood of implementation 521 may also be broken into sub-categories for different combinations of the features (ABC, DEF, GHI). Projected expenses associated with implementation of one or more of the features 102a (Features A-E) corresponding to the selected combination of scope elements 110 during the defined timeframe 515 can also be computed based on the demand metrics 511 for the respective feature(s) A-E relative to the capacity metrics 506 and the associated costs of the respective resource(s) 132 (Teams 1-4) that are available (e.g., corresponding to the selected resource profiles 105) for the defined timeframe 515.

Furthermore, when the demand metrics 511 exceed the capacity metrics 506 for a given timeframe 515 (during the product planning stage), and/or when projected outcome(s) (during the execution stage) and/or projected or actual expenses (during the product planning or execution stage) are undesirable, embodiments of the present disclosure may generate one or more recommendations for modifying the selected combination of scope elements 110. For example, recommendations 523 for varying or moving one or more of the specified features 102a (Features A-E) to a different timeframe 516 associated with a subsequent release version of the product may be generated and presented via the user interface 500, in order to complete others of the specified features, reduce expenses, and/or otherwise improve outcomes for one or more of the features 102a (Features A-E) during the fixed timeframe 515. The likelihood of completion 521 (at the planning stage) and/or the projected outcome (at the execution stage) may thus be dynamically updated responsive to the modification of the scope elements 110.

FIG. 6 illustrates an example user interface 600 generated for use during the execution stage of product-based release in accordance with embodiments of the present disclosure. In particular, FIG. 6 illustrates an example user interface 600 presenting a release health screen in accordance with some embodiments of the present disclosure.

As shown in FIG. 6, the release heath screen user interface 600 provides a situational (time) context to scope status/progress for a release or version (Release Y) of a product (Product X) by generating and presenting visual representations of progress measurements or scores 630a-630e for the features 102a (Features A-E) corresponding to the combination of scope elements 110 that were selected for the timeframe 515. The progress measurements 630a-630e may be computed based on differences between the demand metrics 511 for the respective features 102a (Features A-E) and spent portions the capacity metrics 506 of the respective resources 132 at any given or selected time during the fixed timeframe 515. The actual progress with respect to the specified product features 102a (A-E) to be completed over the fixed timeframe 515 can thus be computed based on the fixed constraints.

In the example of FIG. 6, the progress measurements 630a-630e are based on point values assigned as the capacity and demand metrics for the available resources 132 (Teams 1-4) and features 102a (Features A-E), respectively. The user interface 600 also provides visual representations of statistics including points remaining 681 (e.g., the total of all points outstanding) and release velocity 682. The release velocity 682 may be computed based the already-spent portions (i.e., points retired) of the capacity metrics 506 relative to one or more time intervals (also referred to herein as “sprints”) within the fixed timeframe 515, such as an interval representing a difference between the total time allotted for the fixed timeframe 515 and a remaining portion of the fixed timeframe 515. As such, the user interface 600 further provides visual representations of the timeframe 515 by defining intervals (or “sprints”) representing portions of the fixed timeframe 515.

For example, sprints required 683 may be computed based on a comparison of release velocity versus/relative to points remaining 681, and sprints remaining 684 may be calculated based on the number of planned sprints that are left for the remaining portion of the timeframe 515. The release velocity 682 may be represented as a numerical/point value using a same scale as the points remaining 681, and may be calculated based on current execution pace (points retired per sprint). The release velocity 682 (as calculated during the execution stage) may also be compared against an original or projected velocity estimate/assumption (as calculated during the product planning stage). In some embodiments, (for example, for use in non-agile management applications) the user interface 600 of FIG. 6 may further allow for alteration of constraints (illustrated by underlining 686), for instance, by adding more resources 132 (thus affecting the points/capacity remaining 681 and/or sprints required 683) and/or by extending the timeframe 515 (thus affecting the sprints remaining 684 and/or sprints required 683).

The user interface 600 of FIG. 6 further provides a visual representation of projected outcomes with respect to completion of one or more of the features 102a, which may be computed based on a difference between the demand metrics 511 for the feature(s) 102a and spent portions the capacity metrics 506 of the resources 132 at a given time during the fixed timeframe 515 (as represented by sprints required 683 at the given time) vs. a remaining portion (e.g., sprints remaining 684) of the fixed timeframe and/or based on the release velocity 682. In particular, in the example user interface 600, a color indicator 685 with respect to the sprints remaining 684 may represent the status or likelihood of completion of the currently-selected features 102a (Features A-F) for the release version (Release Y) of the product (Product X). For example, if remaining sprints remaining 684 is less than sprints required 683, the indicator 685 may have a red status, signaling that completion of the release (Y) of the product (X) is unlikely in light of the remaining portion of the fixed timeframe 515. If sprints remaining 684 is equal to sprints required 683, the indicator 685 may have a yellow status, signaling that the release (Y) of the product (X) is on-schedule. If sprints remaining 684 is greater than sprints required 683, the indicator 685 may have a green status, signaling that the release (Y) of the product (X) is ahead of schedule, with a portion of the fixed timeframe 515 leftover. This leftover time may thus be used alternatively, for instance, for further research, preparation for the next release version, etc.

The user interface 600 of FIG. 6 also provides visual representations of the actual expenses 645a-645e incurred at a current or other specified time during the timeframe 515. In particular, based on the fixed resource constraints, and predetermined costs associated therewith, the actual expenses 645a-645e of delivering one or more of the specified product features 102a (Features A-E) may be computed based on spent portions of the capacity metrics 506 of the resources 132 (Teams 1-4) at any time during the fixed timeframe 515. Relative expenses/dollar costs among the respective resources 132 can be reflected by weighting the point values/capacity metrics 506, as some resources/teams 132 may be more expensive than others. The user interface 600 may also generate and present recommendations to utilize a different combination of the respective resources 132 based on a comparison of the costs associated therewith relative to the demand metrics 511 for the combination of features 102a (Features A-E) selected for the timeframe 515.

As illustrated in FIG. 6, embodiments of the present disclosure can allow for real-time analysis and management of product features 102a (represented by scope elements 110) and resources 132 (represented by resource profiles 105), and one or more of the progress measurements 630a-630e, actual costs 645a-645e, and/or projected outcomes can be continually revised responsive to a plurality of changes, including active changes (e.g., changes to the combination of scope elements 110/features 102a), as well as passive changes (e.g., the passage of time within the fixed timeframe 515). As such, any or all of the values or metrics described herein can be recursively computed and updated based on such active or passive changes, thousands or even millions of times during the defined timeframe 515. Thus, analysis and computation performed by embodiments of the present disclosure are incapable of being performed manually, for instance, by a product manager.

FIG. 7 illustrates a user interface 700 for an example capitalization application in accordance with embodiments of the present disclosure. As shown in FIG. 7, the visual representations of the scope elements 110 further indicate categories 701 of tasks that are associated with implementation of the respective features 102a (illustrated in FIG. 7 with reference to Features A-D). The user interface 700 also allows for respective allocations 702 representing spent portions of metrics (e.g., portions of the timeframe 515, portions of the capacity metrics 506), per resource 132, among the categories 701 for one or more of the features 102a. The categories 701 may represent the types of work into which the tasks may be classified or may otherwise correspond. In the example of FIG. 7, the capitalization application user interface 700 can receive, from one or more team members corresponding to one or more of the resources 132, allocations 702 of percentages of time (for example, with respect to the timeframe 515) spent on various task/activities associated with implementation of a particular feature 102a (as identified in particular Charge Codes representing the categories 701 of the tasks/activities). Alternatively, the allocations 702 may represent portions of the capacity metrics 506 (for one or more of the resources 132) that were utilized in implementing a particular feature 102a, as classified into categories 701 of the associated tasks.

Still referring to FIG. 7, based on the respective allocations 702 among the categories 701 of tasks and the respective costs associated with corresponding ones of the resources 132, portions of the actual expense(s) 645a-645e can be identified as capital expenditures. For example, in FIG. 7, the Charge Codes representing the categories 701 of the tasks may be mapped to cost types, and, for ones of the cost types that can be capitalized, capital expenditures can be calculated based on the respective allocations 702. Embodiments of the present disclosure, such as the user interface 700, may enable and/or encourage team members/resources 132 to provide such details as to the type or category of work performed, per deliverable or feature, per time period. In some embodiments, the user interface 700 may be implemented as a mobile device application (for example, for a phone or tablet computer), as a plug-in for IDEs, and/or as part of a Maverick-based timesheet

As described in detail herein, embodiments of the present disclosure can apply multi-factor capacity constraints with drag-and-drop technology. In particular, embodiments may provide the ability to define multiple capacity constraint factors, drag-and-drop handling of teams/resources and features/deliverables, use of time boxes (instead of timescales or Gantts), updating of data based on the current drop location, updating of capacity and demand metrics based on the current drop, and/or updating of scope details based on the current drop, all within a product-based planning context.

Accordingly, embodiments of the present disclosure can combine drag-and-drop planning with financial awareness/cost calculation tracking/capabilities to provide a financially aware drag-and-drop interface for capacity-constrained product planning and release and team planning. Embodiments of the present disclosure thus provide a way for product planners to more easily match features to capacity in a particular product release, with visibility into the corresponding costs both at the time of planning and as progress is made.

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks. As used herein, “a processor” may refer to one or more processors.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the FIGS. illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the FIGS. For example, two blocks shown in succession may, in fact, be executed substantially concurrently, or the blocks may sometimes be executed in the reverse order, depending upon the functionality involved. Although some of the diagrams include arrows on communication paths to show a primary direction of communication, it is to be understood that communication may occur in the opposite direction to the depicted arrows. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

The terminology used herein is for the purpose of describing particular embodiments only and is not intended to be limiting to other embodiments. As used herein, the singular forms “a”, “an” and “the” are intended to include the plural forms as well, unless the context clearly indicates otherwise. It will be further understood that the terms “comprises,” “comprising,” “includes” and/or “including”, “have” and/or “having” (and variants thereof) when used herein, specify the presence of stated features, integers, steps, operations, elements, and/or components, but do not preclude the presence or addition of one or more other features, integers, steps, operations, elements, components, and/or groups thereof. In contrast, the term “consisting of” (and variants thereof) when used in this specification, specifies the stated features, integers, steps, operations, elements, and/or components, and precludes additional features, integers, steps, operations, elements and/or components. Elements described as being “to” perform functions, acts and/or operations may be configured to or otherwise structured to do so. As used herein, the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the various embodiments described herein.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall support claims to any such combination or subcombination.

In the drawings and specification, there have been disclosed typical embodiments and, although specific terms are employed, they are used in a generic and descriptive sense only and not for purposes of limitation, the scope of the disclosure being set forth in the following claims.

What is claimed is:

1. A computer-implemented method, comprising:
performing operations as follows on a processor:
defining a fixed timeframe associated with release of a product;
generating resource profiles comprising capacity metrics indicating capacities of respective resources that are available for the fixed timeframe and respective costs associated therewith;
generating scope elements comprising demand metrics associated with implementation of respective features of the product within the fixed timeframe; and
dynamically computing, for different combinations comprising ones of the scope elements, respective expenses associated with implementation of the respective features thereof based on the demand metrics therefor relative to the capacity metrics of the respective resources that are available for the fixed timeframe.

2. The method of claim 1, wherein the respective expenses comprise projected expenses, and wherein the operations further comprise:
computing, for one of the different combinations, an actual expense of implementation of one of the respective features thereof based on spent portions of the capacity metrics of the respective resources at a time during the fixed timeframe and the respective costs associated therewith; and
presenting, via a user interface of a product management system, a visual representation of the actual expense.

3. The method of claim 2, wherein the operations further comprise:
computing, for the one of the different combinations, a progress measurement with respect to the one of the respective features thereof based on a difference between the demand metrics therefor and the spent portions the capacity metrics of the respective resources at the time during the fixed timeframe; and
presenting, via the user interface of the product management system, a visual representation of the progress measurement.

4. The method of claim 3, wherein the operations further comprise:
computing, for the one of the different combinations, a projected outcome with respect to completion of the one of the respective features thereof based on the difference between the demand metrics therefor and the spent portions the capacity metrics of the respective resources at the time during the fixed timeframe relative to a remaining portion of the fixed timeframe; and
presenting, via the user interface of the product management system, a visual representation of the projected outcome.

5. The method of claim 4, wherein the operations further comprise:
computing, for the one of the respective features, a release velocity based on the spent portions of the capacity metrics relative to a difference between the fixed timeframe and the remaining portion of the fixed timeframe,
wherein computing the projected outcome is further based on the release velocity.

6. The method of claim 2, wherein the scope elements further indicate categories of tasks associated with implementation of the respective features, and wherein the operations further comprise:
determining respective allocations of the spent portions of the capacity metrics among the categories of tasks associated with implementation of the one of the respective features; and
identifying portions of the actual expense as capital expenditures based on the respective allocations of the spent portions of the capacity metrics among the categories of tasks and the respective costs associated with corresponding ones of the resources.

7. The method of claim 4, wherein the operations further comprise:
based on the projected outcome for the one of the respective features, generating a recommendation to modify the ones of the scope elements included in the one of the different combinations;
presenting the recommendation via the user interface of the product management system;
receiving a modification with respect to the ones of the scope elements included in the one of the different combinations; and
dynamically updating the projected outcome based on remaining portions of the capacity metrics of the respective resources responsive to the modification.

8. The method of claim 7, wherein the fixed timeframe comprises a first timeframe, and wherein the operations further comprise:
defining a second timeframe associated with release of a subsequent version of the product,
wherein the recommendation to modify comprises a recommendation to move the one of the respective features from the first timeframe to the second timeframe based on the demand metrics therefor relative to capacity metrics of respective resources that are available for the second timeframe.

9. The method of claim 8, wherein the user interface comprises a drag-and-drop user interface, and wherein receiving the modification comprises:
receiving, via the drag-and-drop user interface, an instruction to move a visual representation of one of the scope elements corresponding to the one of the respective features from a visual representation of the first timeframe to a visual representation of the second timeframe.

10. A computer system, comprising:
a processor; and
a memory coupled to the processor, the memory comprising computer readable program code embodied therein that, when executed by the processor, causes the processor to perform operations comprising:
defining a fixed timeframe associated with release of a product;
generating resource profiles comprising capacity metrics indicating capacities of respective resources that are available for the fixed timeframe and respective costs associated therewith;
generating scope elements comprising demand metrics associated with implementation of respective features of the product within the fixed timeframe; and
dynamically computing, for different combinations comprising ones of the scope elements, respective expenses associated with implementation of the respective features thereof based on the demand metrics therefor relative to the capacity metrics of the respective resources that are available for the fixed timeframe.

11. The computer system of claim 1, wherein the respective expenses comprise projected expenses, and wherein the operations further comprise:
computing, for one of the different combinations, an actual expense of implementation of one of the respective features thereof based on spent portions of the capacity metrics of the respective resources at a time during the fixed timeframe and the respective costs associated therewith; and
presenting, via a user interface of a product management system, a visual representation of the actual expense.

12. The computer system of claim 11, wherein the operations further comprise:
computing, for the one of the different combinations, a progress measurement with respect to implementation of the one of the respective features thereof based on a difference between the demand metrics therefor and the spent portions the capacity metrics of the respective resources at the time during the fixed timeframe; and
presenting, via the user interface of the product management system, a visual representation of the progress measurement.

13. The computer system of claim 12, wherein the operations further comprise:
computing, for the one of the different combinations, a projected outcome with respect to completion of the one of the respective features thereof based on the difference between the demand metrics therefor and the spent portions the capacity metrics of the respective resources at the time during the fixed timeframe relative to a remaining portion of the fixed timeframe; and
presenting, via the user interface of the product management system, a visual representation of the projected outcome.

14. The computer system of claim 11, wherein the scope elements further indicate categories of tasks associated with implementation of the respective features, and wherein the operations further comprise:
determining respective allocations of the spent portions of the capacity metrics among the categories of tasks associated with implementation of the one of the respective features; and
identifying portions of the actual expense as capital expenditures based on the respective allocations of the spent portions of the capacity metrics among the categories of tasks and the respective costs associated with corresponding ones of the resources.

15. The computer system of claim 13, wherein the operations further comprise:
based on the projected outcome for the one of the respective features, generating a recommendation to modify the ones of the scope elements included in the one of the different combinations;
presenting the recommendation via the user interface of the product management system;
receiving a modification with respect to the ones of scope elements included in the one of the different combinations; and
dynamically updating the projected outcome based on remaining portions of the capacity metrics of the respective resources responsive to the modification.

16. A computer program product, comprising:
a computer readable storage medium having computer readable program code embodied in the medium, the computer readable program code comprising:
computer readable code to define a fixed timeframe associated with release of a product;
computer readable code to generate resource profiles comprising capacity metrics indicating capacities of respective resources that are available for the fixed timeframe and respective costs associated therewith;
computer readable code to generate scope elements comprising demand metrics associated with implementation of respective features of the product within the fixed timeframe; and
computer readable code to dynamically compute, for different combinations comprising ones of the scope elements, respective expenses associated with implementation of the respective features thereof based on the demand metrics therefor relative to the capacity metrics of the respective resources that are available for the fixed timeframe.

17. The computer program product of claim 1, wherein the respective expenses comprise projected expenses, and wherein the computer readable program code further comprises:
computer readable code to compute, for one of the different combinations, an actual expense of implementation of one of the respective features thereof based on spent portions of the capacity metrics of the respective resources at a time during the fixed timeframe and the respective costs associated therewith; and
computer readable code to present, via a user interface of a product management system, a visual representation of the actual expense.

18. The computer program product of claim 17, wherein the computer readable program code further comprises:
computer readable code to compute, for the one of the different combinations, a progress measurement with respect to implementation of the one of the respective features thereof based on a difference between the demand metrics therefor and the spent portions the capacity metrics of the respective resources at the time during the fixed timeframe; and
computer readable code to present, via the user interface of the product management system, a visual representation of the progress measurement.

19. The computer program product of claim 18, wherein the computer readable program code further comprises:
computer readable code to compute, for the one of the different combinations, a projected outcome with respect to completion of the one of the respective features thereof based on the difference between the demand metrics therefor and the spent portions the capacity metrics of the respective resources at the time during the fixed timeframe relative to a remaining portion of the fixed timeframe; and
computer readable code to present, via the user interface of the product management system, a visual representation of the projected outcome.

20. The computer program product of claim 16, wherein the scope elements further indicate categories of tasks associated with implementation of the respective features, wherein the computer readable program code further comprises:
computer readable code to determine respective allocations of the spent portions of the capacity metrics among the categories of tasks associated with implementation of the one of the respective features; and
computer readable code to identify portions of the actual expense as capital expenditures based on the respective allocations of the spent portions of the capacity metrics among the categories of tasks and the respective costs associated with corresponding ones of the resources.
